(19) United States
(12) Patent Application Publication
(10) Pub. No.: US 2018/0270002 A1
(43) Pub. Date: Sep. 20, 2018

(54) METHOD, SERVER, USER TERMINAL AND SYSTEM FOR KEY POINTS PROMPT IN LIVE BROADCAST

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Liang LI, BEIJING (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/120,438

(22) PCT Filed: May 26, 2016
(86) PCT No.: PCT/CN2016/083543

§ 371 Date: Aug. 19, 2016

(30) Foreign Application Priority Data
Nov. 30, 2015 (CN) 201510857212.6

(51) Int. Cl. H04H 60/65; H04H 60/27; H04H 60/33

(52) U.S. Cl. CPC H04H 60/65; H04H 2201/16; H04H 60/33; H04H 60/27

(57) ABSTRACT

Disclosed is a method, server, user terminal and system for key points prompt in a live broadcast, includes: receiving an acquisition value of environmental volume acquired in a site of activity in real time from an acquisition device; and comparing the acquisition value with a predetermined prompt threshold; if it is determined that the acquisition value is larger than the predetermined prompt threshold, recording the live broadcast time point corresponding to the acquisition value as a key point; generating a key point prompt notice and sending it to a user terminal; and the user terminal receiving the key point prompt notice to prompt the user.

### CROSS-REFERENCE TO RELATED APPLICATIONS

This application is a continuation application of International Application No. PCT/CN2016/083543, filed on May 26, 2016, which is based upon and claims priority to Chinese Patent Application No. 201510857212.6, filed on Nov. 30, 2015, the entire contents of which are incorporated herein by reference.

### TECHNICAL FIELD

The present application relates to a field of live broadcast technology, and more particular to a method, server, user terminal and system for key points prompt in a live broadcast.

### BACKGROUND

Currently, when users watch a live broadcast of a largescale site activity such as a sports event, a cultural activity, etc., as in offsite environments, the users is likely to miss watching the key points of the live broadcast because the temporary events happened around themselves have to be dealt with. For example, a user might miss the goal time in a live football broadcast or the most favorite song in a live concert broadcast because of answering a phone call. Due to the real time nature of the live broadcast, once the key point of the live broadcast is missed to watch, the user will miss the best audience experience.

The solutions in prior art can only provide a replay function of live program, and the user has to watch the replay afterwards. However, n such solutions, the replay time has elapsed from the live program, so that it is difficult to compensate for the user's experience loss when the user watches the live program.

### SUMMARY

In view of this, an object of an embodiment of the present application is to provide a method, server, user terminal and system for key points prompt in a live broadcast for addressing the problem that the missed key points in the live broadcast cannot be compensated in time.

Based on the above described object of the embodiment of the present application, it is provided a method for key points prompt in a live broadcast. According to an embodiment, the method includes:
receiving an acquisition value of environmental volume acquired in a site of activity in real time from an acquisition device;
comparing the acquisition value with a predetermined prompt threshold; if it is determined that the acquisition value is larger than the predetermined prompt threshold, recording the live broadcast time point corresponding to the acquisition value as a key point; generating a key point prompt notice and sending it to a user terminal; and the user terminal receiving the key point prompt notice to prompt the user.

In some embodiments, after recording the key point, the method further includes:
calling a predetermined clip duration and capturing a live video near the key point according to the clip duration, and generating a key point clip and sending the user terminal a notice of watching the key point clip; and
receiving a first confirmation instruction returned from the user terminal and pushing the key point clip to the user terminal.

In some embodiments, after the live broadcast is ended, the method further includes:
combining all the key point clips to generate a live highlight collection and sending the user terminal a notice of watching the live highlight collection; and
receiving a second confirmation instruction returned from the user terminal, and pushing the live highlight collection to the user terminal.

Another aspect of the present application also provides a method for key points prompt in a live broadcast, the method as an embodiment includes:
receiving a key point prompt notice from a server, wherein the server receives an acquisition value of environmental volume acquired in a site of activity in real time from an acquisition device, and comparing the acquisition value with a predetermined prompt threshold; if it is determined that the acquisition value is larger than the predetermined prompt threshold, recording the live broadcast time point corresponding to the acquisition value as a key point;
prompting a user according to the key point prompt notice.

In some embodiments, after receiving the key point prompt notice, the method further includes:
comparing the live broadcast time point corresponding to the key point prompt notice with the live broadcast time point of local live signals to obtain a difference between them; and
determining whether the difference is smaller than the predetermined delay prompt threshold;
if yes, then immediately prompting the user; if no, then not prompting the user until the live broadcast time point of local live signals run to the live broadcast time point corresponding to the key point prompt notice.

In some embodiments, after prompting the user, the method further includes:
receiving a prompt confirmation instruction from the user; and
if receiving the subsequent key point prompt notice within a predetermined time interval, then not prompting the user.

In some embodiments, the method further includes:
receiving a notice of watching the key point clip from the server;
generating a key point recommendation list according to all the received notice of watching the key point clips;
generating a download request based on a selection instruction from the user and sending it to the server; and
receiving the key point clip pushed by the server.

A further aspect of the present application also provides a server, as an embodiment includes:
a first receiving module, configured to receive an acquisition value of environmental volume acquired in a site of activity in real time from an acquisition device; and
a first executing module, configured to compare the acquisition value with a predetermined prompt threshold; if it is determined that the acquisition value is larger than the predetermined prompt threshold, record the live broadcast time point corresponding to the acquisition value as a key point; generate a key point prompt notice and send it to a user terminal so that the key point prompt notice is received by the user terminal to prompt a user.

In some embodiments, the server further includes:
a clip module, configured to call a predetermined clip duration and capturing a live video near the key point according to the clip duration, and generate a key point clip and sending the user terminal a notice of watching the key point clip; and receive a first confirmation instruction returned from the user terminal and push the key point clip to the user terminal.

In some embodiments, the clip module is further configured to: combine all the key point clips to generate a live highlight collection and send the user terminal a notice of watching the live highlight collection; and receive a second confirmation instruction returned from the user terminal, and push the live highlight collection to the user terminal.

Yet another aspect of the present application also provides a user terminal, as an embodiment includes:
a second receiving module, configured to receiving a key point prompt notice from a server, wherein the server receives an acquisition value of environmental volume acquired in a site of activity in real time from an acquisition device, and compare the acquisition value with a predetermined prompt threshold; if it is determined that the acquisition value is larger than the predetermined prompt threshold, record the live broadcast time point corresponding to the acquisition value as a key point; and
a prompting module, configured to prompt a user according to the key point prompt notice.

In some embodiments, the user terminal further includes:
a second executing module, configured to compare the live broadcast time point corresponding to the key point prompt notice with the live broadcast time point of local live signals to obtain a difference between them; and determine whether the difference is smaller than the predetermined delay prompt threshold; if yes, then allow the prompting module to immediately prompt the user; if no, then allow the prompting module not to prompt the user until the live broadcast time point of local live signals run to the live broadcast time point corresponding to the key point prompt notice.

In some embodiments, the prompting module is further configured to:receive prompt confirmation instruction from the user; and if receive a subsequent key point prompt notice within a predetermined time interval, not prompt the user.

In some embodiments, the user terminal further includes:
a third executing module, configured to receive a notice of watching the key point clip from the server; generate a key point recommendation list according to all the received notice of watching the key point clips; generate a download request based on a user's selection instruction from the user and send it to the server; and receive the key point clip pushed by the server.

Another aspect of the present application also provides a system for key points prompt in a live broadcast, as an embodiment includes:
a server as described in any one of the abovementioned servers; and
a user terminal as described in any one of the abovementioned user terminals.

A further aspect of the present application also provides a server, as an embodiment includes:
at least one processor; and
a memory communicably connected with the at least one processor for storing instructions executable by the at least one processor, wherein execution of the instructions by the at least one processor causes the at least one processor to:
receive an acquisition value of environmental volume acquired in a site of activity in real time from an acquisition device;
compare the acquisition value with a predetermined prompt threshold; if it is determined that the acquisition value is larger than the predetermined prompt threshold, record the live broadcast time point corresponding to the acquisition value as a key point; and generate a key point prompt notice and send it to a user terminal, so that the key point prompt notice is received by the user terminal to prompt a user.

In some embodiments, wherein the at least one processor is further caused to:
call a predetermined clip duration and capturing a live video near the key point according to the clip duration, and generate a key point clip and send the user terminal a notice of watching the key point clip; and
receive a first confirmation instruction returned from the user terminal and push the key point clip to the user terminal.

In some embodiments, wherein the at least one processor is further caused to:
combine all the key point clips to generate a live highlight collection and send the user terminal a notice of watching the live highlight collection; and
receive a second confirmation instruction returned from the user terminal, and push the live highlight collection to the user terminal.

Another aspect of the present application also provides a device, as an embodiment includes:
at least one processor; and
a memory communicably connected with the at least one processor for storing instructions executable by the at least one processor, wherein execution of the instructions by the at least one processor causes the at least one processor to:
receive a key point prompt notice from a server, wherein the server receives an acquisition value of environmental volume acquired in a site of activity in real time from an acquisition device, and compare the acquisition value with a predetermined prompt threshold; if it is determined that the acquisition value is larger than the predetermined prompt threshold, record the live broadcast time point corresponding to the acquisition value as a key point;
prompt a user according to the key point prompt notice.

In some embodiments, wherein the at least one processor is further caused to:
compare the live broadcast time point corresponding to the key point prompt notice with the live broadcast time point of local live signals to obtain a difference between them; and
determine whether the difference is smaller than the predetermined delay prompt threshold; if yes, then prompt the user immediately; if no, then not prompt the user until the live broadcast time point of local live signals run to the live broadcast time point corresponding to the key point prompt notice.

In some embodiments, wherein the at least one processor is further caused to:
receive a prompt confirmation instruction from the user; and
if receive the subsequent key point prompt notice within a predetermined time interval, then not prompt the user.

In some embodiments, wherein the at least one processor is further caused to:
receive a notice of watching the key point clip from the server;
generate a key point recommendation list according to all the received notice of watching the key point clips;
generate a download request based on a selection instruction from the user and send it to the server; and
receive the key point clip pushed by the server.

Another aspect of the present application also provides a system, as an embodiment includes:
a server, includes:
   at least one processor; and
   a memory communicably connected with the at least one processor for storing instructions executable by the at least one processor, wherein execution of the instructions by the at least one processor causes the at least one processor to:
      receive an acquisition value of environmental volume acquired in a site of activity in real time from an acquisition device;
compare the acquisition value with a predetermined prompt threshold; if it is determined that the acquisition value is larger than the predetermined prompt threshold, record the live broadcast time point corresponding to the acquisition value as a key point; and generate a key point prompt notice and send it to a user terminal, so that the key point prompt notice is received by the user terminal to prompt a user; and
a device, comprising:
   at least one processor; and
a memory communicably connected with the at least one processor for storing instructions executable by the at least one processor, wherein execution of the instructions by the at least one processor causes the at least one processor to:
receive a key point prompt notice from a server, wherein the server receives an acquisition value of environmental volume acquired in a site of activity in real time from an acquisition device, and compare the acquisition value with a predetermined prompt threshold; if it is determined that the acquisition value is larger than the predetermined prompt threshold, record the live broadcast time point corresponding to the acquisition value as a key point;
   prompt a user according to the key point prompt notice.

As can be seen from the above, the method, server, user terminal and system can acquire an environmental volume in live site by an acquisition device in real time; determine the key point during the live broadcast by determining the environmental volume level via the server;
and prompting the user via the user terminal. The method and system of embodiments of the present application can prompt the user at the time of key point in live broadcast immediately, to allow the user can focus on watching the live broadcast at the time of key point in the live broadcast, so as to effectively avoid the user's audience experience loss of live broadcast due to missing the key points during the live broadcast.

It should be understood that both the descriptions in general and in detailed are exemplary and explanatory without any limit to the application.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow diagram of a method for key points prompt in a live broadcast according to an embodiment of the present application;

FIG. 2 is a schematic flow diagram of a method for key points prompt in a live broadcast according to another embodiment of the present application;

FIG. 3 is a schematic view of a server according to an embodiment of the present application;

FIG. 4 is a schematic view of a user terminal according to an embodiment of the present application.

FIG. 5 is a schematic flow diagram of a method for key points prompt in a live broadcast according to another embodiment of the present application;

FIG. 6 is a schematic processing sequence diagram of a method for key points prompt in a live broadcast according to another embodiment of the present application; and

FIG. 7 is a schematic view of a system for key points prompt in a live broadcast according to an embodiment of the present application.

The embodiments of the present disclosure have been clearly illustrated through the drawings and will be described in detail hereinafter. These drawings and text description are not intentin any way to limit the scope of the disclosure, but illustrate the concept of the disclosure for the skilled in the art by reference to specific embodiments.

### DETAILED DESCRIPTION

The present application is described more fully hereinafter with reference to the accompanying drawings so that the objects, technical solutions and advantages of the present application will become more apparent.

It will be understood that, the terms “first”, “second” etc. used herein is to distinguish various elements or parameters with the same name for the convenience. The embodiments of the present application should not be limited by these terms and the specific description of these terms for the embodiments would be omitted hereinafter.

During a live broadcast of a large scale site activity, since it takes a long time, it is difficult for a user to ensure to focus on the live broadcast in whole watching process, that is to say, the user may always miss some live contents, but if the missed is a key point in the live broadcast, it will seriously affect the user's audience experience of live broadcast. It will be an available method to prompt the user via a user terminal once a key point is appeared during the live broadcast, to make the user can focus on the live broadcast after received the prompt.
Obviously, in this method, it is main question how to determine the key point during live broadcast. Considering the features of a large scale site activity are a large number of people to participate and the participants are generally consisted of the roles of presenter, performer and audience, so that when a key point (such as a goal in football match or singer singing a classical song in a concert) is appeared, the audience will generally produce a strong reaction, which will cause a significant increase of the environmental volume in the live site than normal period combined with a large number of audience, thereby it is an available and effective way to determine the key point by the environmental volume level in the live site. The embodiments of the present application provides a method, server, user terminal and system for key points prompt in a live broadcast according to the key point determination way.

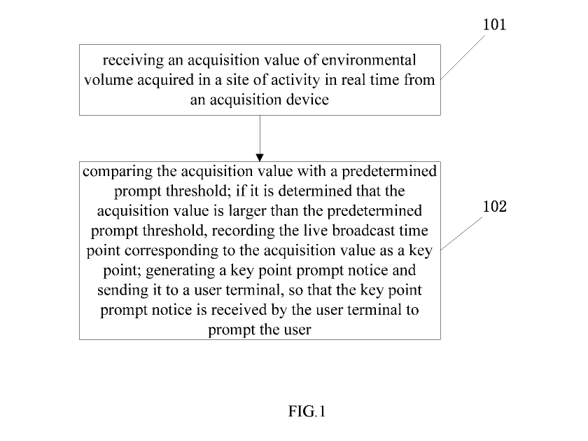

The embodiments of the present application provide a method for key points prompt in a live broadcast. Referring to FIG. 1, it is a schematic flow diagram of a method for key points prompt in a live broadcast according to an embodiment of the present application.

The method for key points prompt in a live broadcast includes:

Step 101: receiving an acquisition value of environmental volume acquired in a site of activity in real time from an acquisition device.

Step 102: comparing the acquisition value with a predetermined prompt threshold; if it is determined that the acquisition value is larger than the predetermined prompt threshold, recording the live broadcast time point corresponding to the acquisition value as a key point; generating a key point prompt notice and sending it to a user terminal, so that key point prompt notice is received by the user terminal to prompt the user.

Preferably, after recording the key point, the method further includes:
calling a predetermined clip duration and capturing a live video near the key point according to the clip duration, and generating a key point clip and sending the user terminal a notice of watching the key point clip; and
receiving a first confirmation instruction returned from the user terminal and pushing the key point clip to the user terminal.

Preferably, after the live broadcast is ended, the method further includes:
combining all the key point clips to generate a live highlight collection and sending the user terminal a notice of watching the live highlight collection; and
receiving a second confirmation instruction returned from the user terminal, and pushing the live highlight collection to the user terminal.

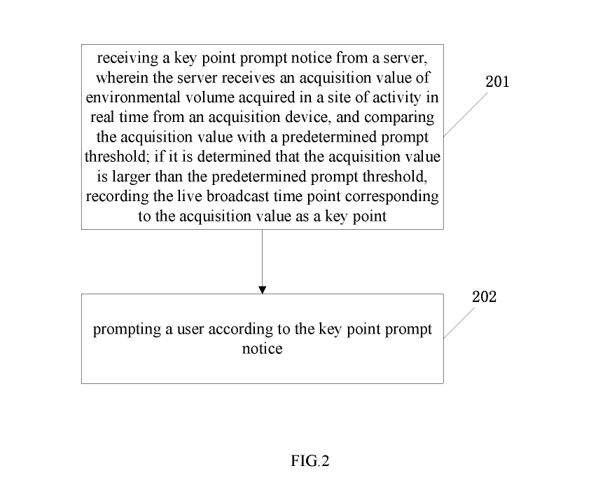

The embodiments of the present application also provide a method for key points prompt in a live broadcast. Referring to FIG. 2, it is a schematic flow diagram of a method for key points prompt in a live broadcast according to another embodiment of the present application.

The method for key points prompt in a live broadcast includes:

Step 201: receiving a key point prompt notice from a server, wherein the server receives an acquisition value of environmental volume acquired in a site of activity in real time from an acquisition device, and comparing the acquisition value with a predetermined prompt threshold; if it is determined that the acquisition value is larger than the predetermined prompt threshold, recording the live broadcast time point corresponding to the acquisition value as a key point.

Step 202: prompting a user according to the key point prompt notice.

Preferably, after receiving the key point prompt notice, the method further includes:
comparing the live broadcast time point corresponding to the key point prompt notice with the live broadcast time point of local live signals to obtain a difference between them; and
determining whether the difference is smaller than the predetermined delay prompt threshold; if yes, then immediately prompting the user; if no, then not prompting the user until the live broadcast time point of local live signals run to the live broadcast time point corresponding to the key point prompt notice.

Preferably, after prompting the user, the method further includes:
Receiving a prompt confirmation instruction from the user; and
if receiving the subsequent key point prompt notice within a predetermined time interval, then not prompting the user.

Preferably, the method further includes:
receiving a notice of watching the key point clip from the server;
generating a key point recommendation list according to all the received notice of watching the key point clips;
generating a download request based on a selection instruction from the user and sending it to the server; and
receiving the key point clip pushed by the server.

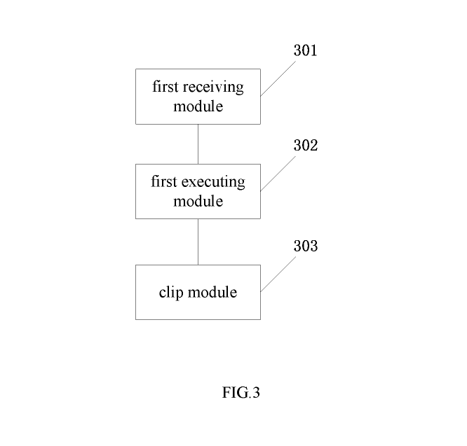

The embodiments of the present application also provide a server. Referring to FIG. 3, it is a schematic view of a server according to an embodiment of the present application.

The server includes:
a first receiving module 301, configured to receive an acquisition value of environmental volume acquired in a site of activity in real time from an acquisition device; and
a first executing module 302, configured to compare the acquisition value with a predetermined prompt threshold; if it is determined that the acquisition value is larger than the predetermined prompt threshold, record the live broadcast time point corresponding to the acquisition value as a key point; generate a key point prompt notice and sending it to a user terminal so that the key point prompt notice is received by the user terminal to prompt a user.

Preferably, the server further includes:
a clip module 303, configured to call a predetermined clip duration and capturing a live video near the key point according to the clip duration, and generate a key point clip and send the user terminal a notice of watching the key point clip; and receive a first confirmation instruction returned from the user terminal and push the key point clip to the user terminal. Furthermore, the clip module 303 is further configured to: combine all the key point clips to generate a live highlight collection and send the user terminal a notice of watching the live highlight collection; and receive a second confirmation instruction returned from the user terminal, and push the live highlight collection to the user terminal.

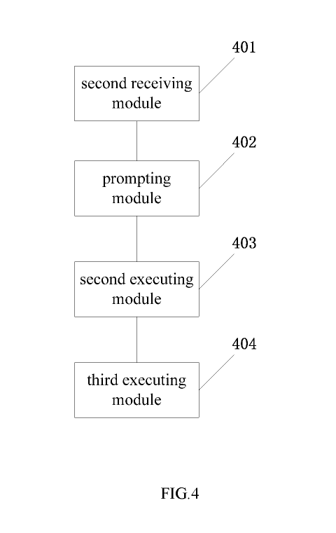

The embodiments of the present application also provide a user terminal. Referring to FIG. 4, it is a schematic view of a user terminal according to an embodiment of the present application.

The user terminal includes:
a second receiving module 401, configured to receive a key point prompt notice from a server, wherein the server receives an acquisition value of environmental volume acquired in a site of activity in real time from an acquisition device, and compare the acquisition value with a predetermined prompt threshold; if it is determined that the acquisition value is larger than the predetermined prompt threshold, record the live broadcast time point corresponding to the acquisition value as a key point; and
a prompting module 402, configured to prompt a user according to the key point prompt notice.

Preferably, the user terminal further includes:
a second executing module 403, configured to compare the live broadcast time point corresponding to the key point prompt notice with the live broadcast time point of local live signals to obtain a difference between them; and determine whether the difference is smaller than the predetermined delay prompt threshold; if yes, then allow the prompting module 402 to immediately prompt the user; if no, then allow the prompting module 402 not to prompt the user until the live broadcast time point of local live signals run to the live broadcast time point corresponding to the key point prompt notice.

Preferably, the prompting module 402 is further configured to: receive the user's prompter confirmation instruction; and if receive the subsequent key point prompt notice within a predetermined time interval, then not prompt the user.

Preferably, the user terminal further includes:
a third executing module 404, configured to receive a notice of watching the key point clip from the server; generate a key point recommendation list according to all the received watching notices of the key point clip; generate a download request based on a selection instruction from the user and send it to the server; and receive the key point clip pushed by the server.

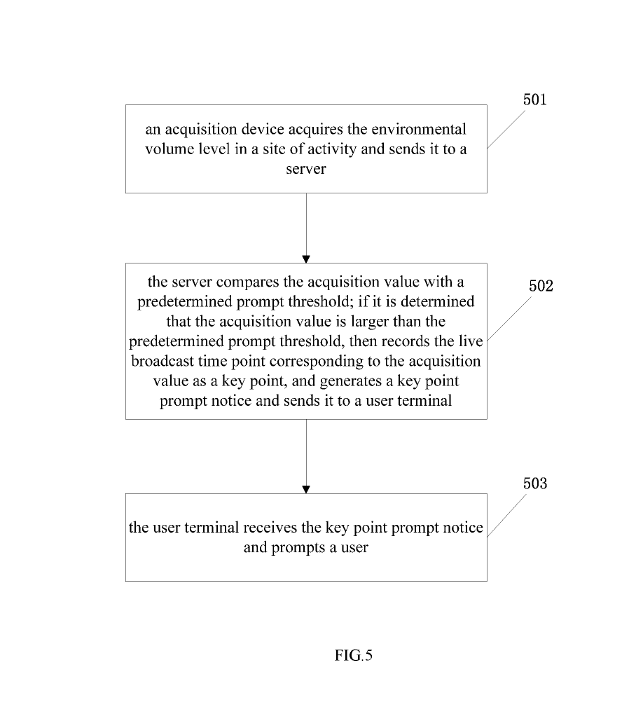

Referring to FIG. 5, it is a schematic flow diagram of a method for key points prompt in a live broadcast according to another embodiment of the present application.

In this embodiment, the method for key points prompt in a live broadcast includes:

Step 501: an acquisition device acquires the environmental volume level in a site of activity and sends it to a server.

The acquisition device arranged at a gathering spot of people in the site of activity acquires the environmental volume level in the site of activity in real time and sends the acquisition value to the server.

Step 502: the server compares the acquisition value with a predetermined prompt threshold; if it is determined that the acquisition value is larger than the predetermined prompt threshold, then records the live broadcast time point corresponding to the acquisition value as a key point, and generates a key point prompt notice and sends it to a user terminal.

After the server receives the acquisition value of environmental volume in the site of activity sent by the acquisition device, the server will compare the acquisition value with a predetermined prompt threshold. If the acquisition value is larger than the predetermined prompt threshold, it means that the people in the site of activity produces a strong reaction and a key point in live broadcast is deemed to be appeared, then the server will record the live broadcast time point corresponding to the acquisition value as a key point, and generate a key point prompt notice corresponding to the key point and send it to a user terminal.

Step 503: the user terminal receives the key point prompt notice and prompts a user.

After the user terminal receives the key point prompt notice, it will immediately prompt the user to allow the user can focus on watching the live broadcast in order to avoid the missing of the key point in live broadcast. As a means for the user terminal to prompt the user, the user terminal can emit a prompt tone and/or produce vibration to prompt, for example, during the user watches a live broadcast by a smart terminal device such as a smart phone or a pad, when emitting a prompt as a key point is appeared, the smart phone or the pad will emit a ring tone alert or a vibration alert or a ring tone and vibration alert; and as another means to prompt the user, the user terminal can send a prompt notice to another terminal bound to the user terminal;
the another terminal is generally selected from a terminal commonly used by the user but which is not being used for watching the live broadcast, and the another terminal can be bound to the user terminal by preset for receiving the prompt notice sent from the user terminal, for example, during the user watches a live broadcast by a smart terminal device such as a smart TV or a computer, when emitting a prompt notice as a key point is appeared, the smart TV or the computer will send a message to the user's mobile phone to prompt.

As can be seen from the above, by the method of the embodiment, the acquisition device can acquire an environmental volume in live site in real time, when the server determines that the acquisition value of environmental volume in a site of activity is larger than the predetermined prompt threshold, it can record the time point and send a key point prompt notice to the user terminal, and the user terminal once receiving the key point prompt notice will immediately prompt the user, so as to allow the user can focus on watching the live broadcast. The method of the embodiment of the present application can prompt the user to pay attention to watch the key points in live broadcast, so as to simply, effectively and efficiently address the relevant problem existed in prior art.

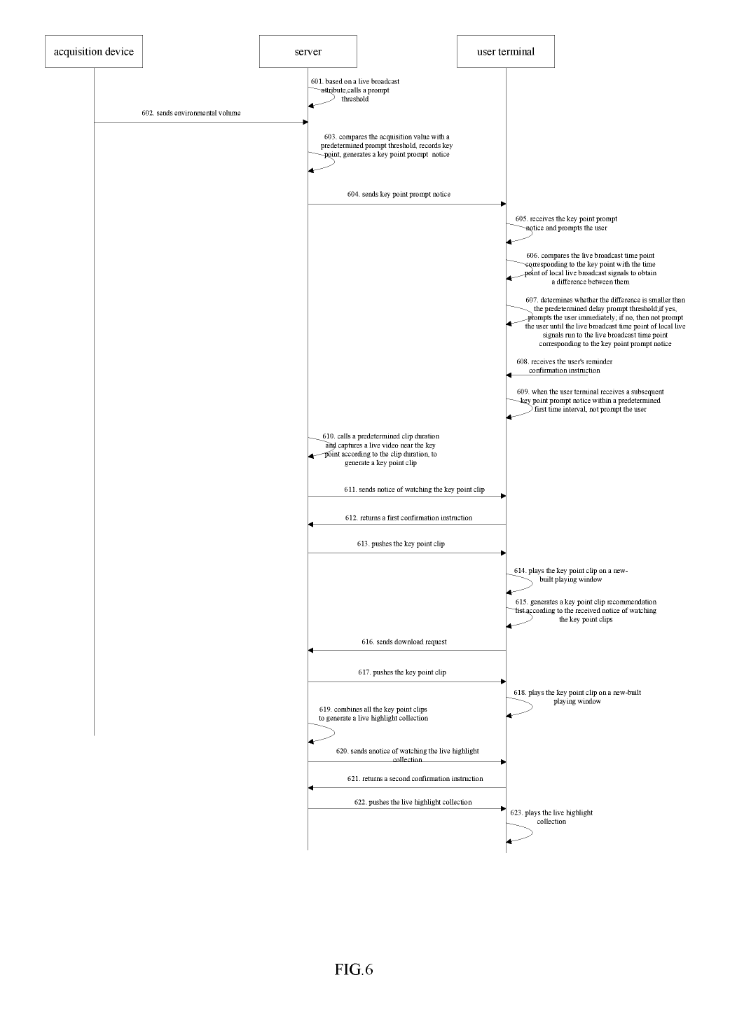

Hereinafter, a method for key points prompt in a live broadcast according to an embodiment of the present application will be further described by a specific example of the present application. Referring to FIG. 6, it is a schematic processing sequence diagram of a method for key points prompt in a live broadcast according to another embodiment of the present application.

In the embodiment, the method for key points prompt in a live broadcast includes:

Step 601: based on alive broadcast attribute of the current live broadcast, the server calls a prompt threshold adaptable for the attribute from a predetermined prompt threshold list.

A predetermined prompt threshold list is preset in the server, in which several prompt thresholds are stored, and each prompt threshold is adaptable for a live broadcast attribute. The live broadcast attribute is typically used for representing the type and/or participants size of the live broadcasting activity. The activity type can includes sporting event, theatrical performance, meeting, etc.; and the participants size of activity can be classified by the number of participants, such as small (less than 100), medium (100 to 500 people), large (more than 500). Among them, in sporting event and theatrical performance, the audience (also as participants)may generally be highly reactive and have a large number of people, so that the prompt threshold adaptable for sporting event and theatrical performance is relatively high in general. In meeting, the participants may generally not appear too intense reaction and the number of people is not too much, so that in comparison with sporting event and theatrical performance, the prompt threshold adaptable for meeting is relatively low. By the step of calling a predetermined prompt threshold in this step, the determination of key point in live broadcast can be more accurate.

Step 602: an acquisition device acquires the environmental volume level in a site of activity and sends it to a server.

Step 603: the server compares the acquisition value with a predetermined prompt threshold, if it is determined that the acquisition value is larger than the predetermined prompt threshold, then records the live broadcast time point corresponding to the acquisition value as a key point, and generates a key point prompt notice.

Step 604: the server sends the key point prompt notice to a user terminal.

Step 605: the user terminal receives the key point prompt notice and prompts the user.

Through the step 601-605, a basic process of key points prompt in live broadcast is completed. Due to the delay of network transmission, the local live broadcast signals received by the user terminal may have a delay than the real site of activity, but the time of the server to determine the key point and send the key point prompt notice to the user terminal can “fill up” the delay, that is to say, when the user terminal receives the key point prompt notice, the local live broadcast signals can just run to the live broadcast time point corresponding to the key point prompt notice, so as to achieve the key point prompting effect.

In some circumstances, due to the failure of network transmission, the local live broadcast signals received by the user terminal may have a long time delay than the real site of activity, at this time if the user terminal prompts the user immediately once receiving the key point prompt notice sent by the server, it may cause an effect like “spoiler” and affect the audience experience. Therefore, in this embodiment, after the user terminal receives the key point prompt notice, further includes:

Step 606: the user terminal compares the live broadcast time point corresponding to the key point with the time point of local live broadcast signals to obtain a difference between them.

The user terminal once receiving the key point prompt notice can acquire the live broadcast time point of the real activity site corresponding to the key point prompt notice and acquire the playing time point of local live broadcast signals to obtain the difference by subtracting between the both, wherein the difference will be several seconds or several minutes in general.

Step 607: the user terminal determines whether the difference is smaller than the predetermined delay prompt threshold; if yes, prompts the user immediately; if no, then not prompt the user until the live broadcast time point of local live signals run to the live broadcast time point corresponding to the key point prompt notice.

The predetermined delay prompt threshold is a predetermined time value which is generally several seconds. When the difference is smaller than the predetermined delay prompt threshold, it means that the local playing live broadcast signals only have a little delay than the real, so that the immediate prompt to the user once receiving the key point prompt notice should be happened at the time that the local playing live broadcast signals is running to the key point corresponding to the key point prompt notice or slightly earlier than the key point, which can achieve a good effect of key point prompt. When the difference is larger than the predetermined delay prompt threshold, it means that the local playing live broadcast signals is much delayed than the real, so that if the user terminal prompts the user immediately once receiving the key point prompt notice sent by the server, it may cause an spoiler, in order to avoid the circumstance, when the difference is larger than the predetermined delay prompt threshold, the user terminal pauses the prompt to the user once receiving the key point prompt notice, and does not prompt the user until the live broadcast time point of local live broadcast signals runs to the key point

Through the steps 606 and 607, the problem of the key point prompt effect is affected by the delay of network transmission can be avoided to further improve the key point prompt effect.

When the key point is happened in live broadcast, the strong reaction of people in activity site will last for a while, at this time multiple key points will be recorded in accordance with the method of the embodiments of the present application, and multiple key point prompt notices will be generated and sent to the user, but all the key point prompt notices actually correspond to one key point, if the user terminal prompts all the successive key point prompt notices, then it will occupy too much processing resource and reduce the audience experience. In this embodiment, further includes:

Step 608: the user terminal receives the user's prompt confirmation instruction.

After receiving the prompt, the user already has focus on the live broadcast, and then the user can input a prompt confirmation instruction into the user terminal for showing that the prompt has been received successfully.

Step 609: when the user terminal receives a subsequent key point prompt notice within a predetermined first time interval, not prompt the user.

After receiving the user's prompt confirmation instruction, if the user terminal receives a subsequent key point prompt notice within a predetermined time interval, no more prompt notice is sent to the user to avoid the problem of occupied resource and reduced audience experience due to the successive prompts to the user. The predetermined first time interval is generally several seconds, but can be set to different value based on the different activity type. Preferably, the user terminal can request for the live broadcast attribute of the current live broadcast, and then call a specific first time interval adaptable for the live broadcast attribute from the local profile. Multiple first time intervals adaptable for different live broadcast attributes are preset in the local profile.

In this embodiment, after recording the key point, the method further includes:

Step 610: the server calls predetermined clip duration and captures a live video near the key point according to the clip duration, to generate a key point clip.

In the process of live broadcast, with the progress of live broadcast, the live video will be synchronically stored. After recording the key point, the server will call the live video and capture a section of live video near the key point by the running time of the clip duration according to the predetermined clip duration, to generate a short video, namely a key point clip. The key point clip records the contents happened before and after the time of the key point, and can record the whole process of the key point from begin to end.

Step 611: the server sends a notice of watching the key point clip to the user terminal.

After generating the key point clip, the server generates a notice of watching the key point clip corresponding to the key point clip to the user terminal.

Step 612: the user terminal returns a first confirmation instruction.

After the user terminal receives the notice of watching the key point clip, a prompt is ejected to the user for prompting the user there is a key point clip to be able to watch. When the user confirms to watch, the user inputs the first confirmation instruction and the user terminal returns the first confirmation instruction to the server.

Step 613: the server pushes the key point clip to the user terminal.

Step 614: the user terminal plays the key point clip on a new built playing window.

After the user terminal receives the key point clip pushed by the server, it newly build a playing window to play the key point clip.

Through the steps 610-614, during or after the end of live broadcast, the user can watch the key point clips of all the key points as his own selection and review the live broadcast content happened before and after the key point.

Based on the key point clip in the embodiment, during the running of live broadcast, the method further includes:

Step 615: the user terminal generates a key point clip recommendation list according to the received notice of watching the key point clips.

The user terminal generates a key point clip recommendation list according to all the notice of watching the key point clips received in the preparation process for prompting the user that how many key points happened in previous live broadcast and allow the user to select a key point clip of any one of the key points to watch.

Step 616: the user terminal generates a download request according to the user's selection instruction and sends it to the server.

The user inputs a selection instruction for the key point clip recommendation list to select the key point clip of interest and the user terminal accordingly generates a download request and sends it to the server.

Step 617: the server selects the key point clip designated by the download request according to the download request and pushes it to the user terminal.

The server receives the download request and selects the key point clip designated by the download request according to the download request and pushes it to the user terminal.

Step 618: the user terminal plays the key point clip on a new built playing window.

After the user terminal receives the key point clip pushed by the server, it newly builds a playing window to play the key point clip.

Through the steps 615618, the user can be allowed to select any one of previous key points to watch its key point clip during the live broadcast.

Based on the key point clip in the embodiment, after the live broadcast is ended, the method further includes:

Step 619: the server combines all the key point clips to generate a live highlight collection

After the live broadcast is ended, the server combines all the key point clips into a video, namely a live highlight collection, and the live highlight collection records all the key point contents in the live broadcast.

Step 620: the server sends a notice of watching the live highlight collection to the user terminal.

After generating the live highlight collection, the server again generates a notice of watching the live highlight collection and the server sends the notice of watching the live highlight collection to the user terminal.

Step 621: the user terminal returns a second confirmation instruction.

After the user terminal receives the notice of watching the live highlight collection, ejects a prompt to the user for prompting the user there is a live highlight collection to be able to watch, and when the user watches, inputs a second confirmation instruction and the user terminal sends the second confirmation instruction to the server.

Step 622: the server pushes the live highlight collection to the user terminal.

Step 623: the user terminal plays the live highlight collection.

After the user terminal receives the live highlight collection pushed by the server, the user terminal plays the live highlight collection on the original playing window or another new built playing window.

Through the steps 619-623, a live highlight collection is pushed to the use after the live broadcast is ended, and the live highlight collection is consisted of all the key point clips and records all key point contents in the live broadcast, which allows the user can review all the wonderful contents immediately after the live broadcast is ended.

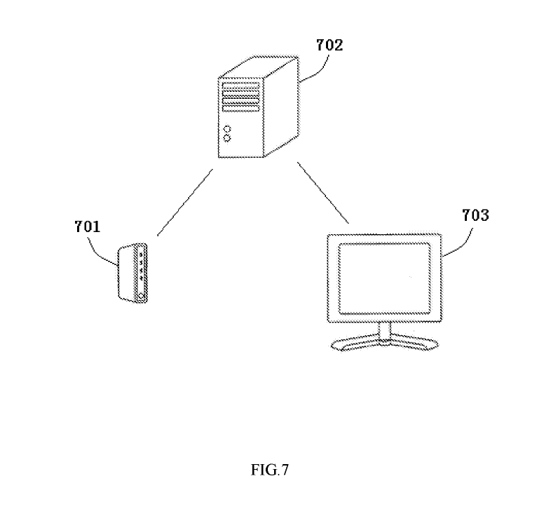

In another aspect, the embodiments of the present application also provides a system for key points prompt in a live broadcast. Referring to FIG. 7, it is a schematic view of a system for key points prompt in a live broadcast according to an embodiment of the present application. The system includes an acquisition device 701, a server 702 and a user terminal 703, wherein:

The acquisition device 701 is located on the activity site, specifically it is arranged at the people gathering spots in the activity site and the number of the acquisition devices can be one or more. The acquisition device 701 is used for acquiring the environmental volume level in the activity site in real time and sending the acquisition value to the server 702.

The server 702 is arranged at network end for receiving the acquisition value of the environmental volume level in the activity site sent by the acquisition device 701, and then comparing the acquisition value with a predetermined prompt threshold; if it is determined that the acquisition value is larger than the predetermined prompt threshold, recording the live broadcast time point corresponding to the acquisition value as a key point; generating a key point prompt notice and sending it to the user terminal 703. In the case of multiple acquisition devices 701, the server 702 can determine whether most of the acquisition values of the environmental volume level in the activity site sent by the acquisition devices are larger than the predetermined prompt threshold, in which the most means more than 50%.

The user terminal 703 is provided at user end, for receiving the key point prompt notice sent by the server 702 and prompting the user. The means of prompting the user includes: the user terminal emitting a prompt tone, vibration of the user terminal, and sending a prompt message to another terminal.

It should be noted that, the server 702 provided at network end only shows the location of the server 702 in the data interactive structure, but when the server 702 is installed as a specific device, the server 702 can be arranged in the activity site together with the acquisition device 701; further, the server 702 can also be the same specific device as the acquisition device 701, that is, the acquisition device 701 is a function unit having a voice acquisition function of the server 702.

Preferably, the user terminal 703 is further used for after receiving the key point prompt notice, comparing the live broadcast time point corresponding to the key point prompt notice with the live broadcast time point of local live signals to obtain a difference between them; and determining whether the difference is smaller than the predetermined delay prompt threshold; if yes, then immediately prompting the user; if no, not prompting the user until the live broadcast time point of local live signals run to the live broadcast time point corresponding to the key point prompt notice.

Preferably, the user terminal 703 is further used for after prompting the user, receiving the user's prompt confirmation instruction; and if receiving the subsequent key point prompt notice within a predetermined second time interval, then not prompting the user.

Preferably, the server 702 is further used for after recording the key point, calling a predetermined clip duration and capturing a live video near the key point according to the clip duration, and generating a key point clip and sending the user terminal 703 a notice of watching the key point clip; and receiving a first confirmation instruction returned from the user terminal 703 and pushing the key point clip to the user terminal 703; the user terminal 703 is further used for playing the key point clip on a new built playing window.

Preferably, the user terminal 703 is further used for generating a key point recommendation list according to all the received notice of watching the key point clip s in the live broadcast; generating a download request based on a user's selection instruction and sending it to the server 702; and playing the key point clip pushed by the server 702 on a new built playing window.

Preferably, the server 702 is further used for after the live broadcast is ended, combining all the key point clips to generate a live highlight collection and sending the user terminal a notice of watching the live highlight collection; and receiving a second confirmation instruction returned from the user terminal, and pushing the live highlight collection to the user terminal; the user terminal 703 is further used for playing the live highlight collection.

In another aspect of the present application, it is also provided a server, as an embodiment includes:
at least one processor; and
a memory communicably connected with the at least one processor for storing instructions executable by the at least one processor, wherein execution of the instructions by the at least one processor causes the at least one processor to:
receive an acquisition value of environmental volume acquired in a site of activity in real time from an acquisition device;
compare the acquisition value with a predetermined prompt threshold; if it is determined that the acquisition value is larger than the predetermined prompt threshold, record the live broadcast time point corresponding to the acquisition value as a key point; and generate a key point prompt notice and send it to a user terminal, so that the key point prompt notice is received by the user terminal to prompt a user.

Preferably, the at least one processor is further caused to:
call a predetermined clip duration and capturing a live video near the key point according to the clip duration, and generate a key point clip and send the user terminal a notice of watching the key point clip; and
receive a first confirmation instruction returned from the user terminal and push the key point clip to the user terminal.

Preferably, the at least one processor is further caused to:
combine all the key point clips to generate a live highlight collection and send the user terminal a notice of watching the live highlight collection; and
receive a second confirmation instruction returned from the user terminal, and push the live highlight collection to the user terminal.

Another aspect of the present application also provides a device, as an embodiment includes:
at least one processor; and
a memory communicably connected with the at least one processor for storing instructions executable by the at least one processor, wherein execution of the instructions by the at least one processor causes the at least one processor to:
receive a key point prompt notice from a server, wherein the server receives an acquisition value of environmental volume acquired in a site of activity in real time from an acquisition device, and compare the acquisition value with a predetermined prompt threshold; if it is determined that the acquisition value is larger than the predetermined prompt threshold, record the live broadcast time point corresponding to the acquisition value as a key point; and
prompt a user according to the key point prompt notice.

Preferably, the at least one processor is further caused to:
compare the live broadcast time point corresponding to the key point prompt notice with the live broadcast time point of local live signals to obtain a difference between them; and
determine whether the difference is smaller than the predetermined delay prompt threshold; if yes, then prompt the user immediately; if no, then not prompt the user until the live broadcast time point of local live signals run to the live broadcast time point corresponding to the key point prompt notice.

Preferably, the at least one processor is further caused to:
receive a prompt confirmation instruction from the user; and
if receive the subsequent key point prompt notice within a predetermined time interval, then not prompt the user.

Preferably, the at least one processor is further caused to:
receive a notice of watching the key point clip from the server;
generate a key point recommendation list according to all the received notice of watching the key point clips;
generate a download request based on a selection instruction from the user and send it to the server; and
receive the key point clip pushed by the server.

Another aspect of the present application also provides a system, as an embodiment includes:
a server, comprising:
   at least one processor; and
   a memory communicably connected with the at least one processor for storing instructions executable by the at least one processor, wherein execution of the instructions by the at least one processor causes the at least one processor to:
      receive an acquisition value of environmental volume acquired in a site of activity in real time from an acquisition device;
      compare the acquisition value with a predetermined prompt threshold; if it is determined that the acquisition value is larger than the predetermined prompt threshold, record the live broadcast time point corresponding to the acquisition value as a key point; and generate a key point prompt notice and send it to a user terminal, so that the key point prompt notice is received by the user terminal to prompt a user; and
a device, comprising:
   at least one processor; and
   a memory communicably connected with the at least one processor for storing instructions executable by the at least one processor, wherein execution of the instructions by the at least one processor causes the at least one processor to:
      receive a key point prompt notice from a server, wherein the server receives an acquisition value of environmental volume acquired in a site of activity in real time from an acquisition device, and compare the acquisition value with a predetermined prompt threshold; if it is determined that the acquisition value is larger than the predetermined prompt threshold, record the live broadcast time point corresponding to the acquisition value as a key point;
      prompt a user according to the key point prompt notice.

In addition, typically, the device of the present disclosure can be a variety of electronic terminal devices such as mobile phone, personal digital assistant (PDA), tablet PC (PAD), smart TV, etc., so that the scope of the disclosure should not be limited to a specific type of electronic device. The system of the present disclosure can be applied in any one of the above electronic terminal device in the form of electronic hardware, computer software or a combination thereof.

Furthermore, the method according to the present disclosure may also be implemented as a computer program executed by CPU, and the computer program may be stored in a computer readable storage medium. When the computer program is executed by CPU, the above functions defined in the methods of the present disclosure are executed.

Furthermore, the above described method steps and system units can also be implemented by using a controller and a computer readable storage medium for storing a computer program to make the controller to implement the above steps or unit functions.

Additionally, it should be appreciated that the computer readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As an example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct RambusRAM (DRRAM). The disclosed aspects of the storage devices are intended to include, but not limited to these and other suitable types of memory.

Those skilled in the art will also understand that a combination of the illustrative logical sections, modules, circuits, and algorithm steps described in this disclosure may be implemented as electronic hardware, computer software, or both. To clearly illustrate the interchangeability between hardware and software, various illustrative components, sections, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical sections, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of the steps of method or algorithm described herein may be contained directly in hardware, software module executed by a processor, or both. The software module may reside in RAM memory, flash memory, ROM memory, EPROM memory, EEPROM memory, registers, hard disk, removable disk, CDROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer readable medium. Computer readable medium includes both computer storage medium and communication medium, and the communication medium includes any medium contributed to transmit a computer program from one place to another. The storage medium may be any available medium accessible by a general purpose or special purpose computer. As an example without any restriction, the computer readable medium can include RAM, ROM, EEPROM, CDROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CDROM disc (CD), laser disc, optical disc, digital versatile disc (DVD), floppy disk and Blu-ray disc where the disk usually reproduces data magnetically and the disc reproduces data optically with lasers. Combinations of the above should also be included within the scope of computer readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present application, and there are many other variations of the different aspects of the present application as described herein without description in the details for simplicity. Thus, any omissions, modifications, equivalent replacements and improvements made in the spirit and principles of the present application should be included within the scopes of the present application.

What is claimed is:

1. A method for key points prompt in a live broadcast, which is applied by an electronic device, comprising:
receiving an acquisition value of environmental volume acquired in a site of activity in real time from an acquisition device; and
comparing the acquisition value with a predetermined prompt threshold; and
if it is determined that the acquisition value is larger than the predetermined prompt threshold, recording the live broadcast time point corresponding to the acquisition value as a key point;
and generating a key point prompt notice and sending it to a user terminal, so that the key point prompt notice is received by the user terminal to prompt a user.

2. The method according to claim 1, wherein after recording the key point, the method further comprises:
calling a predetermined clip duration and capturing a live video near the key point according to the clip duration, and generating a key point clip and sending the user terminal a notice of watching the key point clip; and
receiving a first confirmation instruction returned from the user terminal, and pushing the key point clip to the user terminal.

3. The method according to claim 2, wherein after the live broadcast is ended, the method further comprises:
combining all the key point clips to generate a live highlight collection and sending the user terminal a notice of watching the live highlight collection; and
receiving a second confirmation instruction returned from the user terminal, and pushing the live highlight collection to the user terminal.

4. A method for key points prompt in a live broadcast, which is applied by server, comprising:
receiving a key point prompt notice from a server, wherein the server receives an acquisition value of environmental volume acquired in a site of activity in real time from an acquisition device, and comparing the acquisition value with a predetermined prompt threshold; if it is determined that the acquisition value is larger than the predetermined prompt threshold, recording the live broadcast time point corresponding to the acquisition value as a key point; and
prompting a user according to the key point prompt notice.

5. The method according to claim 4, wherein after receiving the key point prompt notice, the method further comprises:
comparing the live broadcast time point corresponding to the key point prompt notice with the live broadcast time point of local live signals to obtain a difference between them; and
determining whether the difference is smaller than a predetermined delay prompt threshold; if yes, prompting the user immediately; if no, then not prompting the user until the live broadcast time point of local live signals run to the live broadcast time point corresponding to the key point prompt notice.

6. The method according to claim 4, whereinafter prompting the user, the method further comprises:
Receiving a prompt confirmation instruction from the user; and
if receiving a subsequent key point prompt notice within a predetermined time interval, not prompting the user.

7. The method according to claim 4, wherein the method further comprises:
receiving a notice of watching the key point clip from the server;
generating a key point recommendation list according to all the received notice of watching the key point clips;
generating a download request based on a selection instruction from the user and sending it to the server; and
receiving the key point clip pushed by the server,
an acquisition

8. A server, comprising:
at least one processor; and
a memory communicably connected with the at least one processor for storing instructions executable by the at least one processor, wherein execution of the instructions by the at least one processor causes the at least one processor to:
receive an acquisition value of environmental volume acquired in a site of activity in real time from an acquisition device;
compare the acquisition value with a predetermined prompt threshold; if it is determined that the acquisition value is larger than the predetermined prompt threshold, record the live broadcast time point corresponding to the acquisition value as a key point; and generate a key point prompt notice and send it to a user terminal so that the key point prompt notice is received by the user terminal to prompt a user.

9. The server according to claim 8, wherein the at least one processor is further caused to:
call a predetermined clip duration and capturing a live video near the key point according to the clip duration, and generate a key point clip and send the user terminal a notice of watching the key point clip; and
receive a first confirmation instruction returned from the user terminal and push the key point clip to the user terminal.

10. The server according to claim 9, wherein the at least one processor is further caused to:
combine all the key point clips to generate a live highlight collection and send the user terminal a notice of watching the live highlight collection; and
receive a second confirmation instruction returned from the user terminal, and push the live highlight collection to the user terminal.

11. A device, comprising:
at least one processor; and
a memory communicably connected with the at least one processor for storing instructions executable by the at least one processor, wherein execution of the instructions by the at least one processor causes the at least one processor to:
receive a key point prompt notice from a server, wherein the server receives an acquisition value of environmental volume acquired in a site of activity in real time from an acquisition device, and compare the acquisition value with a predetermined prompt threshold; if it is determined that the acquisition value is larger than the predetermined prompt threshold, record the live broadcast time point corresponding to the acquisition value as a key point;
prompt a user according to the key point prompt notice.

12. The device according to claim 11, wherein the at least one processor is further caused to:
compare the live broadcast time point corresponding to the key point prompt notice with the live broadcast time point of local live signals to obtain a difference between them; and
determine whether the difference is smaller than the predetermined delay prompt threshold; if yes, then prompt the user immediately; if no, then not prompt the user until the live broadcast time point of local live signals run to the live broadcast time point corresponding to the key point prompt notice.

13. The device according to claim 11, wherein the at least one processor is further caused to:
receive a prompt confirmation instruction from the user; and
if receive the subsequent key point prompt notice within a predetermined time interval, then not prompt the user.

14. The device according to claim 11, wherein the at least one processor is further caused to:
receive a notice of watching the key point clip from the server;
generate a key point recommendation list according to all the received notice of watching the key point clips;
generate a download request based on a selection instruction from the user and send it to the server; and
receive the key point clip pushed by the server.

15. A system, comprising:
a server, comprising:
at least one processor; and
a memory communicably connected with the at least one processor for storing instructions executable by the at least one processor, wherein execution of the instructions by the at least one processor causes the at least one processor to:
receive an acquisition value of environmental volume acquired in a site of activity in real time from an acquisition device; and
compare the acquisition value with a predetermined prompt threshold; if it is determined that the acquisition value is larger than the predetermined prompt threshold, record the live broadcast time point corresponding to the acquisition value as a key point; and
generate a key point prompt notice and send it to a user terminal, so that the key point prompt notice is received by the user terminal to prompt a user; and
a device, comprising:
at least one processor; and
a memory communicably connected with the at least one processor for storing instructions executable by the at least one processor, wherein execution of the instructions by the at least one processor causes the at least one processor to:
receive a key point prompt notice from a server, wherein the server receives an acquisition value of environmental volume acquired in a site of activity in real time from an acquisition device, and compare the acquisition value with a predetermined prompt threshold; if it is determined that the acquisition value is larger than the predetermined prompt threshold, record the live broadcast time point corresponding to the acquisition value as a key point; and
prompt a user according to the key point prompt notice.
